(19) United States
(12) Patent Application Publication
(10) Pub. No.: US 2016/0198684 A1
(43) Pub. Date: Jul. 14, 2016

(54) TAIL-SNAP COLLAR

(71) Applicants: BRENT P. KEUCH, COLUMBUS, OH (US); JESSICA L. LEIDECKER, COLUMBUS, OH (US)

(72) Inventors: BRENT P. KEUCH, COLUMBUS, OH (US); JESSICA L. LEIDECKER, COLUMBUS, OH (US)

(21) Appl. No.: 14/993,568

(22) Filed: Jan. 12, 2016

Related U.S. Application Data
(60) Provisional application No. 62/102,615, filed on Jan. 13, 2015.

(51) Int. Cl. A01K 27/00; A44B 11/18; A44B 17/00

(52) U.S. Cl. CPC A01K 27/001; A44B 17/0023; A44B 11/18

(57) ABSTRACT

A field collar for sporting dogs, which is made with a securable tail end to avoid the problems of it getting caught in brush and bramble, and of the tail end curling up.

### CROSS-REFERENCE TO RELATED APPLICATION

This application claims the benefit of U.S. Provisional Application No. 62/102,615, filed Jan. 13, 2015.

### BACKGROUND OF THE INVENTION

The first collars for dogs go back to Ancient Greece, and from then to now the overall purpose and design of the actual collar has not changed a whole lot. Artistic embellishments on the collar from engraving, embossing, and etching, to adding brass nameplates, bells, and spikes have left the basic structuring unaffected. Field collars are necessary equipment for tracking and hunting dogs. A problem with the collars used in the past is allowing the tail end to be loose or unsecured, which leads to the loose end curling up and catching on the brush. Over time in the field, the collar gets put to the test with the dogs going in and out of the brush and water. Traditionally, hunters might cut off the loose end, which makes it more difficult to fit the collar, or they might tape the tail end to the rest of the collar, which makes it more difficult to remove and replace. That problem or limitation on the collar used for outdoor dogs led to this invention.

The present invention provides an improved adjustable animal collar that is durable, and is structured to prevent the past problems with field collars and which will work for any terrain: brush, field, and water. The present invention includes a tail-snap design that usefully solves the one major issue that so many hunters face in the field. The tail-snap is structured to keep the leather tail from catching or collecting brush or bending back and breaking. Also, the present invention, avoids past means that complicated putting on and taking the collar off the dog, by its inventive use of releasably securing the tail end to the sliding keeper.

### DESCRIPTION OF THE DRAWINGS

FIG. 1 is a top view of the present invention when it is joined and in use on the animal.

FIG. 2 is a front view of the embodiment of the invention depicted in FIG. 1.

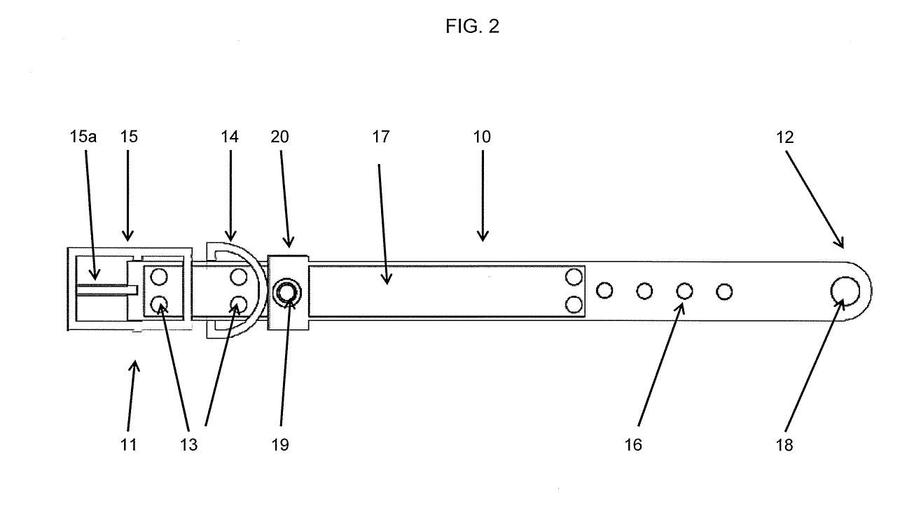

### DESCRIPTION OF ONE PREFERRED EMBODIMENT

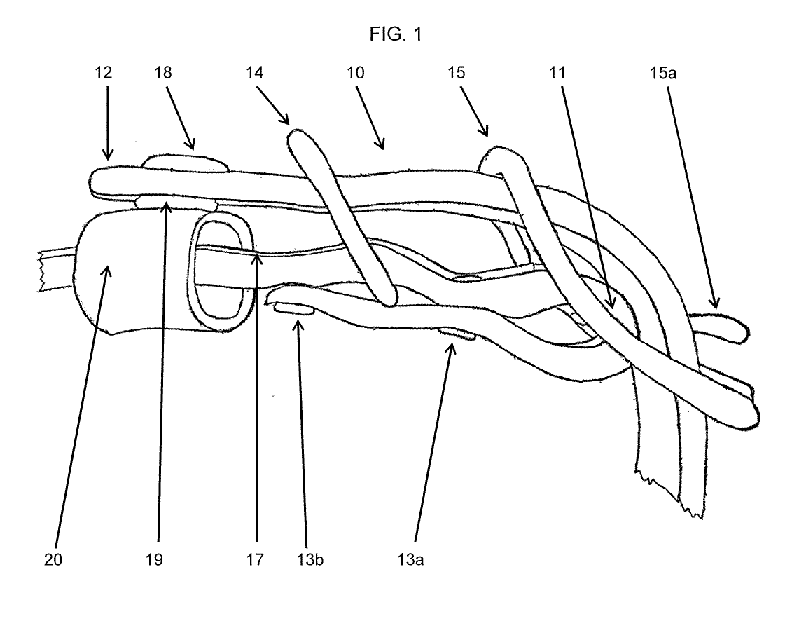

The present invention is a length of flexible leather strap material as depicted in the FIG. 1 embodiment. The strap 10 is a narrow piece of durable, resilient and flexible material, preferably leather. The typical width of the strap is around one and a half inches, and the length is around ten inches. The strap 10 has a loop end 11 and a tail end 12. When the present invention is used, the strap 10 encircles the neck of the animal, the tail end 12 is fitted through the buckle 15 and past the D-ring 14, a predetermined distance.

The loop end 11 is formed by a portion of the strap 10 at its end being folded under the length of the strap 10, with the folded portion being joined to the strap 10 with pairs of rivets 13. A first pair of rivets 13a are secured through, and a predetermined distance from the end of the strap 10 that forms a first loop for receiving the buckle 15. A D-ring 14, preferably made of metal, is fitted adjacent to the first loop, with the bar of the D-ring 14 between the length of the strap and the folded over potion. To secure where the D-ring 14 is fitted, a second pair of rivets 13b are attached through the folded portion and the strap, forming a second loop. This second loop is where the loop end 11 terminates. The tail end 12 will be folded and pass-through the D-ring 14 when the present invention is in use. The frame of the D-ring 14 will stop the folding tail end 12 from moving away from the loop end 11. A frame-and-prong buckle 15, preferably made of metal, is fitted in the first loop with the bar of the buckle 15 staying secured to the strap by the closed loop. The buckle 15 has frames, a central bar, and a prong 15a. The preferable buckle 15 is one with the frames bent from the central bar, with the short sides tilted away from the strap 10. One end of the prong 15a is attached to the central bar with the bar going through the prong, while the other end of the prong touches the left frame. When the present invention is in use, the tail end 12 will pass through the buckle 15, and the prong will go through one of the holes 16 located near the tail end 12. The buckle is bent from the center because it allows the frames to keep the folding tail end 12 from moving away from the loop end 11 without bending the tail end 12 too much. The second pair of rivets 13b attach also to and through one end of a predetermined length of wax cotton fabric 17 on the strap 10. Starting from the loop end 11, it is preferable to apply the piece of wax cotton 17 to cover nearly ⅔ of the length of the strap 10. The other end of the wax cotton 17 is attached to the strap 10 by a third pair of rivets 13c. The preferred wax cotton fabric 17 is water-resistant, making the leather strap 10 more durable, and situated to fit underneath the tail end when it is in place under the D-ring. Staring from where the wax cotton 17 ends are a plurality of holes 16 on the strap 10. The holes 16 are proximate the tail end 12 of the strap. The diameter of the holes 16 is predetermined to be slightly larger than the diameter of the buckle prong 15a. This allows the prong to go through one of the holes 16 when the present invention is in use.

The tail end 12 terminates in a semicircular shape, and a cap portion of a snap fastener 18 attached through the tail end 12. A snap fastener is a pair of interlocking discs preferably made of metal and is normally used in place of buttons for fastener purpose. The cap portion of the snap fastener 18 is a disc with a circular lip. The socket portion of the snap fastener 19 is a disc with a groove on the top. The lip of the cap portion 18 fits into the groove of the socket portion 15. The lip and groove hold the cap portion 18 and socket portion 19 until a certain amount of force is applied to take them apart. The receiver or socket portion of the snap fastener 19 is attached through a sliding keeper 20. The sliding keeper 20 or slider is a narrow piece made of durable material, preferably leather, of a diameter predeterminately sized to loop around the strap. The sliding keeper 20 is not connected to the strap 10, therefore can be moved on the strap 10. This allows the sliding keeper to adjust to various collar tightness, and to keep the tail end secured. The sliding keeper 20 cannot be move beyond the D-ring 14. The sliding keeper 20 is put on the strap 10 by having the tail end 12 pass through the sliding keeper 20. Preferably the size of the sliding keeper is predetermined in part by it being less than the circumference of the snap fastener and the tail end, which serves to keep it from sliding off the strap.

When the present invention is use, the strap 10 is folded and forms a circular shape around the neck of the animal (not shown). FIG. 1 shows the relationship of the loop end 11 and tail end 12 as well as the tail end and the sliding keeper 20 when the present invention is in use.

The strap 10, plurality of holes 17, D-ring 14, sliding keeper 20, and buckle 15 are located predetermined distances apart, such that the tail end will pass through the buckle 15 and the buckle prong will go through within one of the holes 17 on the strap 10, then the tail end 12 will pass through the D-ring 14 and the sliding keeper 20 will move to where the cap portion of the snap fastener 18 will snap onto the socket portion of the snap fastener 19. The buckle 15 frame and D-ring 14 frame keep the tail end 12 secure against the strap 10.

In summary, when the present invention is in use, the tail end 12 will fold and pass though the buckle 15, then the D-ring 14, and snaps onto the sliding keeper 20. That way no matter what size the animal's neck is, the left over piece of the tail end 12 will be secured to the rest of the collar. As so constructed, the tail snap collar provides solutions to the problems with prior art collars.

We claim:

1. A collar comprising a length of flexible strap material having a first or tail end and a second or loop end, with the cap portion of closeable snap attached through said tail end and adjacent thereto; said strap having a plurality of holes therethrough and more proximate to said tail end than to said loop end; said loop end formed by a short end portion of the strap being folded over the length of said strap and said folded over portion being joined to said strap with one or more rivets, a first riveting forming the loop end, then a second riveting forming a second loop; within said loop end is placed the central bar of a buckle having a frame and a prong, and within said second loop the straight portion of a D-ring is fitted; a overlayer length of material is joined to said strap over the portion thereof not having said plurality of holes therethrough; a moveable keeper is fitted around but is not connected to said strap, said keeper having the receiver of a closeable snap attached thereto; said strap, said plurality of holes, said D-Ring, said moveable keeper, and said buckle being located predetermined distances apart, such that said tail end will pass through said frame of said buckle and said prong of said buckle will fit within one of said holes on said strap, then said tail end will pass through said D-ring and said moveable keeper will move to where said cap portion of said closeable snap on said tail end will snap onto said receiver of said closeable snap on said moveable keeper.

2. The collar of claim 1, said tail end terminating in a semicircular shape, and said first riveting is a first pair of rivets, and said second riveting is a second pair of rivets.

3. The collar of claim 1, said overlayer length of material is a predetermined length of wax cotton fabric.
